(19) United States
(12) Patent Application Publication
(10) Pub. No.: US 2024/0369450 A1
(43) Pub. Date: Nov. 7, 2024

(54) ENGINE ASSEMBLY FOR A VEHICLE AND METHOD FOR DETERMINING PISTON TEMPERATURE IN AN ENGINE

(71) Applicant: BRP-ROTAX GMBH & CO. KG, Gunskirchen (AT)

(72) Inventors: Michael SEYRL, Wels (AT); Roland ENNSMANN, Gunskirchen (AT)

(21) Appl. No.: 18/682,292

(22) PCT Filed: Aug. 12, 2022
(86) PCT No.: PCT/EP2022/072661

§ 371 Date: Feb. 8, 2024

Related U.S. Application Data
(60) Provisional application No. 63/232,243, filed on Aug. 12, 2021.

(51) Int. Cl. G01M 15/04; F02B 75/02; F02B 75/18; F02B 77/08

(52) U.S. Cl. CPC G01M 15/048; F02B 75/02; F02B 75/18; F02B 77/085; F02B 2075/025; F02B 2075/1808

(57) ABSTRACT

An engine assembly for a vehicle and method for determining piston component temperature. The assembly includes an engine defining at least one cylinder, the engine including at least one piston disposed in the at least one cylinder, the at least one piston and the at least one cylinder together defining at least in part at least one variable volume combustion chamber; and at least one temperature sensor connected to the engine, the at least one temperature sensor being arranged to measure a temperature of fluid within the at least one combustion chamber.

### CROSS-REFERENCE

The present application claims priority from U.S. Provisional Patent Application No. 63/232,243, entitled “Engine Assembly for a Vehicle and Method for Determining Piston Temperature in an Engine,” filed on Aug. 12, 2021, the entirety of which is incorporated by reference herein.

### FIELD OF THE TECHNOLOGY

The present technology relates to vehicle engine assemblies and methods for determining piston temperature in engines.

### BACKGROUND

For internal combustion engines, such as those used in snowmobiles, the efficiency of the combustion process can be increased by compressing the air entering the engine. This can be accomplished using a turbocharger connected to the air intake and exhaust systems of the snowmobiles.

While use of a turbocharger to increase air pressure can aid in improving engines efficiency, the process of compression can also cause the air to heat. Heating of air in a turbocharger can come from both a pressure-related temperature rise due to the pressure-temperature relationship, as well as conduction of heat from exhaust gas turning the turbine through the turbocharger to the compressor.

When compressed air from the turbocharger is too hot, the efficiency and performance of the engine can suffer due to engine detonation. Also referred to as “knocking”, engine detonation decreases engine efficiency by consuming a portion of the air-gas mixture at the wrong part of the stroke cycle of the engine. Knocking can also occur when the engine or pistons therein become too hot.

There is thus a desire for vehicle systems for monitoring engine heating.

### SUMMARY

It is an object of the present technology to ameliorate at least some of the inconveniences present in the prior art.

According to one aspect of the present technology, there is provided a vehicle and an engine assembly thereof. The engine assembly includes temperature sensors for determining the temperature of some or all of the engine pistons. Each temperature sensor is arranged to determine the temperature inside a cylinder of the engine, and more specifically of the fluid in a combustion chamber defined by the cylinder, piston and a cylinder head of the engine. The temperature of the piston therein is determined by a linear offset, or addition of a constant, to the temperature of the fluid in the combustion chamber. The sensors are connected to and extend through the cylinder head of the engine and into the combustion chamber. Measuring the temperature in the combustion chamber directly, and deducing an estimated piston temperature therefrom, provides a system to aid in knock reduction where engine and/or operational values could be adjusted to reduce intake air temperature and/or piston temperature before reaching a critical temperature. According to another aspect of the present technology, there is provided a method for determining piston temperature in the engine. The method includes determining, or measuring, the temperature of the fluid in the combustion chamber and determining the piston temperature based on the temperature of the fluid in the combustion chamber. The temperature of the piston therein is calculated using a linear offset. Specifically, the piston temperature of a given cylinder of the engine is calculated by adding a predetermined constant to the determined temperature of the fluid in the combustion chamber of the given cylinder.

According to one aspect of the present technology, there is provided an engine assembly for a vehicle. The assembly includes an engine defining at least one cylinder, the engine including at least one piston disposed in the at least one cylinder, the at least one piston and the at least one cylinder together defining at least in part at least one variable volume combustion chamber; and at least one temperature sensor connected to the engine, the at least one temperature sensor being arranged to measure a temperature of fluid within the at least one combustion chamber.

In some embodiments, the engine includes an engine block, and a cylinder head connected to the engine block; the at least one cylinder is defined by the engine block; the at least one combustion chamber being defined by the at least one piston, the at least one cylinder and the cylinder head; and the at least one temperature sensor is connected to the cylinder head.

In some embodiments, the at least one temperature sensor extends through the cylinder head and partially into the at least one combustion chamber.

In some embodiments, the at least one temperature sensor is received in and extends through a sensor sleeve connected to the cylinder head.

In some embodiments, the at least one cylinder includes: a first cylinder, and a second cylinder; the at least one combustion chamber includes: a first combustion chamber defined in part by the first cylinder, and a second combustion chamber defined in part by the second cylinder; the at least one piston includes: a first piston disposed in the first cylinder, and a second piston disposed in the second cylinder; and the at least one temperature sensor is arranged to measure a temperature of fluid within at least one of the first combustion chamber and the second combustion chamber.

In some embodiments, the at least one temperature sensor includes: a first temperature sensor arranged to measure a first temperature of fluid within the first combustion chamber; and a second temperature sensor arranged to measure a second temperature of fluid within the second combustion chamber.

In some embodiments, the first temperature sensor is connected to the cylinder head; and the second temperature sensor is connected to the cylinder head.

In some embodiments, the first temperature sensor extends through a first opening in the cylinder head and at least partially in the first combustion chamber; and the second temperature sensor extends through a second opening in the cylinder head and at least partially in the second combustion chamber.

In some embodiments, the engine is a two-stroke engine.

In some embodiments, the engine assembly further includes a turbocharger operatively connected to the engine.

In some embodiments, the at least one temperature sensor is a thermocouple extending at least partially into the at least one combustion chamber.

In some embodiments, the at least one temperature sensor is in contact with the fluid within the at least one combustion chamber.

In some embodiments, at least part of the at least one temperature sensor extends into that at least one combustion chamber.

According to another aspect of the present technology, there is provided a vehicle including a frame; an engine supported by the frame, the engine defining at least one cylinder, the engine including at least one piston disposed in the at least one cylinder, the at least one piston and that at least one cylinder together defining at least in part at least one variable volume combustion chamber; at least one temperature sensor connected to the engine, the at least one temperature sensor being arranged to measure a temperature of fluid within the at least one combustion chamber.

In some embodiments, the at least one cylinder includes: a first cylinder defined in the engine, and a second cylinder defined in the engine; the at least one combustion chamber includes: a first combustion chamber defined in part by the first cylinder, and a second combustion chamber defined in part by the second cylinder; the at least one piston includes: a first piston disposed in the first cylinder, and a second piston disposed in the second cylinder; and the at least one temperature sensor is arranged to measure a temperature of fluid within at least one of the first combustion chamber and the second combustion chamber.

In some embodiments, the at least one temperature sensor includes: a first temperature sensor arranged to measure a first temperature of fluid within the first combustion chamber; and a second temperature sensor arranged to measure a second temperature of fluid within the second combustion chamber.

In some embodiments, the engine includes an engine block, and a cylinder head connected to the engine block; the first combustion chamber is defined by the engine block, the first piston, and the cylinder head; the second combustion chamber is defined by the engine block, the second piston, and the cylinder head; the first temperature sensor is connected to the cylinder head; and the second temperature sensor is connected to the cylinder head.

In some embodiments, the first temperature sensor extends through a first opening in the cylinder head and at least partially in the first combustion chamber; and the second temperature sensor extends through a second opening in the cylinder head and at least partially in the second combustion chamber.

In some embodiments, the engine is a two-stroke engine.

In some embodiments, the vehicle further includes a turbocharger fluidly connected to the engine.

In some embodiments, the vehicle further includes at least one ski connected to the frame; and the vehicle is a snowmobile.

In some embodiments, the at least one temperature sensor is in contact with the fluid within the at least one combustion chamber.

In some embodiments, at least part of the at least one temperature sensor extends into that at least one combustion chamber.

According to yet another aspect of the present technology, there is provided a method for determining a component temperature in an engine, the method being performed by a controller of a vehicle. The method includes determining, by at least one temperature sensor connected to the controller, a chamber temperature of at least one combustion chamber of the engine, at least part of the at least one temperature sensor being in contact with fluid within the at least one combustion chamber; and determining, by the controller, the component temperature based on the chamber temperature.

In some embodiments, determining the component temperature comprises determining at least one of: a piston temperature of at least one piston of the engine; a piston boss temperature of at least one piston boss of the engine; and a piston pin temperature of at least one piston pin of the engine.

In some embodiments, determining the component temperature includes calculating the component temperature based on the chamber temperature.

In some embodiments, calculating the component temperature comprises applying a linear offset value to the chamber temperature.

In some embodiments, the method further includes calibrating the temperature sensor by determining the linear offset value between a given chamber temperature and a given component temperature.

In some embodiments, determining the chamber temperature of the at least one combustion chamber includes determining a first chamber temperature of a first combustion chamber of the engine, and determining a second chamber temperature of a second combustion chamber of the engine; determining the component temperature based on the chamber temperature includes determining a first temperature for a first piston at least partially defining the first combustion chamber based on the first chamber temperature, and determining a second temperature for a second piston at least partially defining the combustion chamber based on the second chamber temperature.

For purposes of this application, the term “fluid” is meant to include at least both gases and liquids, as well as a combination of gases and liquids.

For purposes of this application, terms related to spatial orientation such as forwardly, rearward, upwardly, downwardly, left, and right, are as they would normally be understood by a driver of the snowmobile sitting thereon in a normal riding position. Terms related to spatial orientation when describing or referring to components or sub-assemblies of the snowmobile, separately from the snowmobile, such as a heat exchanger for example, should be understood as they would be understood when these components or sub-assemblies are mounted to the snowmobile, unless specified otherwise in this application.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein. The explanations provided above regarding the above terms take precedence over explanations of these terms that may be found in any one of the documents incorporated herein by reference.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of a snowmobile;

FIG. 2 is a top, rear, right side perspective view of an engine, air intake system and exhaust system of the snowmobile of FIG. 1;

FIG. 3 is a cross-sectional view of the engine and some portions of the air intake system and the exhaust system of FIG. 2;

FIG. 4 is a top, rear perspective view of a cylinder head of the engine of FIG. 2;

FIG. 5 is a front, bottom perspective view of the cylinder head of FIG. 4;

FIG. 6 is a top plan view of the cylinder head of FIG. 4;

FIG. 7 is a cross-sectional view of the cylinder head of FIG. 4, taken along line 7-7 of FIG. 6;

FIG. 8 is a cross-sectional view of a portion of the cylinder head of FIG. 4, taken along line 8-8 of FIG. 6;

FIG. 9 is a perspective view of a temperature sensor of the cylinder head of FIG. 4;

FIG. 10 is a perspective view of a sensor sleeve of the cylinder head of FIG. 4;

FIG. 11 is an end-on view of the sensor sleeve of FIG. 10;

FIG. 12 is a cross-sectional view of the sensor sleeve of FIG. 10, taken along line 12-12 of FIG. 11; and

FIG. 13 is a flowchart illustrating a method for determining piston temperature in the engine of FIG. 2.

It should be noted that the Figures may not be drawn to scale, except where otherwise noted.

### DETAILED DESCRIPTION

The present technology is described herein with respect to a snowmobile 10 having an internal combustion engine and two skis. However, it is contemplated that some aspects of the present technology may apply to other types of vehicles such as, but not limited to, snowmobiles with a single ski, road vehicles having two, three, or four wheels, off-road vehicles, all-terrain vehicles, side-by-side vehicles, and personal watercraft.

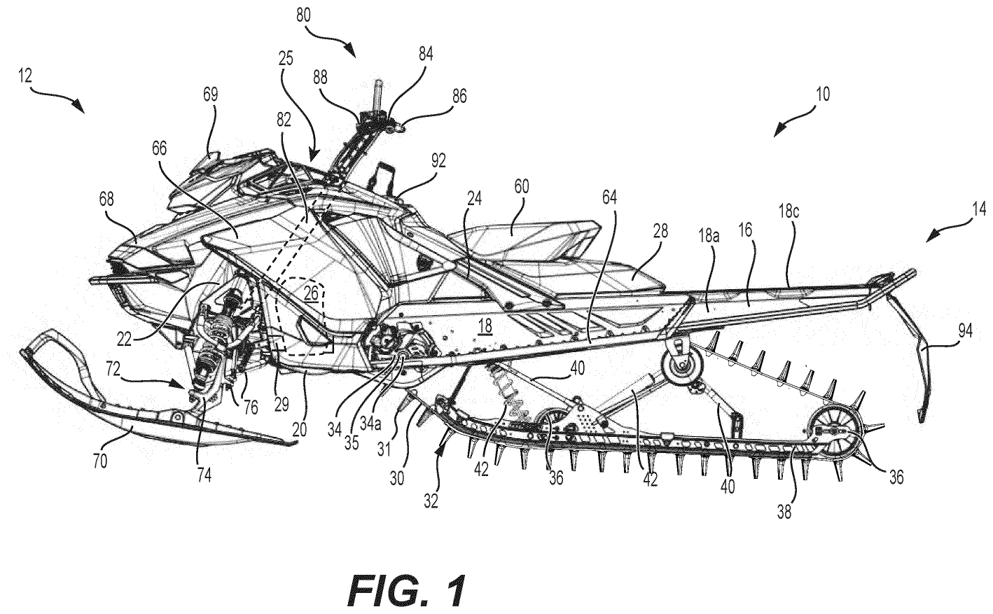

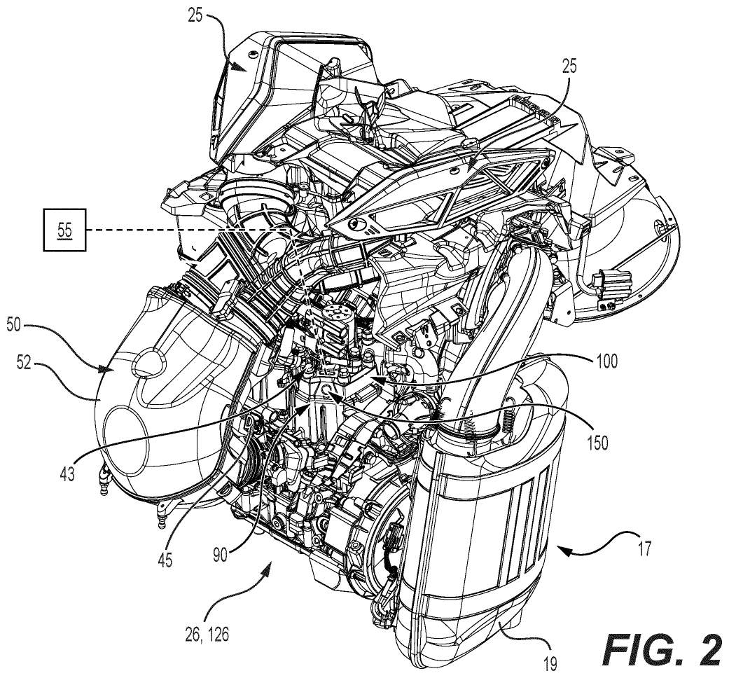

With reference to FIGS. 1 and 2, a snowmobile 10 according to the present technology will be described. The snowmobile 10 includes a forward end 12 and a rearward end 14. The snowmobile 10 includes a vehicle body in the form of a frame or chassis 16 which includes a tunnel 18, an engine cradle portion 20, a front suspension module 22 and an upper structure 24.

An engine assembly 126, including an internal combustion engine 26 and two temperature sensors 150 connected thereto, is carried in an engine compartment defined in part by the engine cradle portion 20 of the frame 16. The engine 26 receives air from an air intake system 50. A fuel tank 28, supported above the tunnel 18, supplies fuel to the engine 26 for its operation. The engine assembly 126, the engine 26, and the sensors 150 are described in further detail below.

An endless drive track 30 is disposed generally under the tunnel 18 and is operatively connected to the engine 26 through a belt transmission system and a reduction drive (not shown). The endless drive track 30 is driven to run about a rear suspension assembly 32 operatively connected to the tunnel 18 for propulsion of the snowmobile 10. The endless drive track 30 has a plurality of lugs 31 extending from an outer surface thereof to provide traction to the track 30.

The rear suspension assembly 32 includes drive sprockets 34, idler wheels 36 and a pair of slide rails 38 in sliding contact with the endless drive track 30. The drive sprockets 34 are mounted on an axle 35 and define a sprocket axis 34a. The axle 35 is operatively connected to a crankshaft (not shown) of the engine 26. The slide rails 38 are attached to the tunnel 18 by front and rear suspension arms 40 and shock absorbers 42. It is contemplated that the snowmobile 10 could be provided with a different implementation of a rear suspension assembly 32 than the one shown herein.

A straddle seat 60 is positioned atop the fuel tank 28. A fuel tank filler opening covered by a cap 92 is disposed on the upper surface of the fuel tank 28 in front of the seat 60. It is contemplated that the fuel tank filler opening could be disposed elsewhere on the fuel tank 28. The seat 60 is adapted to accommodate a driver of the snowmobile 10. The seat 60 could also be configured to accommodate a passenger. A footrest 64 is positioned on each side of the snowmobile 10 below the seat 60 to accommodate the driver's feet.

At the front end 12 of the snowmobile 10, fairings 66 enclose the engine 26 and the belt transmission system, thereby providing an external shell that not only protects the engine 26 and the transmission system but can also make the snowmobile 10 more aesthetically pleasing. The fairings 66 include a hood 68 and one or more side panels which can be opened to allow access to the engine 26. A windshield 69 connected to the fairings 66 acts as a wind screen to lessen the force of the air on the rider while the snowmobile 10 is moving.

Two skis 70 positioned at the forward end 12 of the snowmobile 10 are attached to the front suspension module 22 of the frame 16 through a front suspension assembly 72. The front suspension module 22 is connected to the front end of the engine cradle portion 20. The front suspension assembly 72 includes ski legs 74, supporting arms 76 and ball joints (not shown) for operatively connecting to the respective ski leg 74, supporting arms 76 and a steering column 82 (schematically illustrated).

A steering assembly 80, including the steering column 82 and a handlebar 84, is provided generally forward of the seat 60. The steering column 82 is rotatably connected to the frame 16. The lower end of the steering column 82 is connected to the ski legs 74 via steering rods (not shown). The handlebar 84 is attached to the upper end of the steering column 82. The handlebar 84 is positioned in front of the seat 60. The handlebar 84 is used to rotate the steering column 82, and thereby the skis 70, in order to steer the snowmobile 10. A throttle operator 86 in the form of a thumb-actuated throttle lever is mounted to the right side of the handlebar 84. Other types of throttle operators, such as a finger-actuated throttle lever and a twist grip, are also contemplated. A brake actuator 88, in the form of a hand brake lever, is provided on the left side of the handlebar 84 for braking the snowmobile 10 in a known manner. It is contemplated that the windshield 69 could be connected directly to the handlebar 84.

At the rear end of the snowmobile 10, a snow flap 94 extends downward from the rear end of the tunnel 18. The snow flap 94 protects against dirt and snow that can be projected upward from the drive track 30 when the snowmobile 10 is being propelled by the moving drive track 30. It is contemplated that the snow flap 94 could be omitted.

The snowmobile 10 includes other components such as a display cluster, and the like. As it is believed that these components would be readily recognized by one of ordinary skill in the art, further explanation and description of these components will not be provided herein. Further details regarding such snowmobiles can be found in U.S. Pat. No. 10,526,045, issued on Jan. 7, 2020 and U.S. Pat. No. 10,865,700, issued on Dec. 15, 2020, the entirety of both of which is incorporated herein by reference.

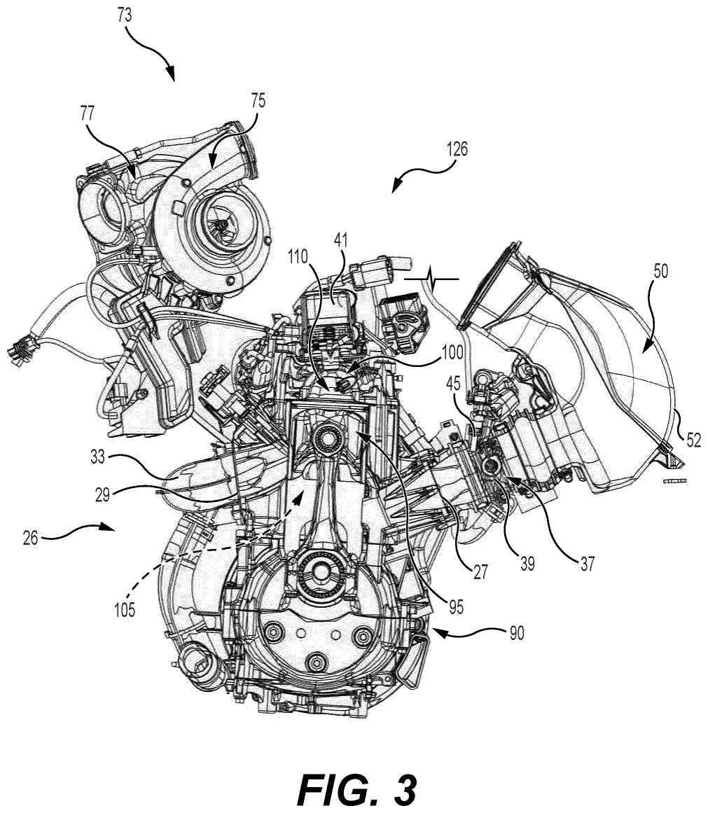

With additional reference to FIG. 3, the engine assembly 126 is illustrated in more detail. The assembly 126 includes the engine 26, which in the present embodiment is an inline, two-cylinder, two-stroke, internal combustion engine 26. The engine 26 is formed from an engine block 90 and a cylinder head 100 connected to the block 90. Two cylinders 105 are defined by the engine block 90 and the cylinder head 100. The engine 26 includes two pistons 95, one piston 95 being disposed in each of the cylinders 105. The cylinders 105 are oriented with their cylinder axes disposed vertically. Two variable volume combustion chambers 110, where engine combustion occurs to drive the pistons 95, are defined in the engine 26. Specifically, each combustion chamber 110 is defined between the corresponding cylinder 105, the corresponding piston 95, and the cylinder head 100. It is contemplated that the engine 26 could be configured differently. For example, the engine 26 could have more or less than two cylinders 105/combustion chambers 110, and the cylinders 105 could be arranged in a V-configuration instead of in-line. It is contemplated that in some implementations the engine 26 could be a four-stroke internal combustion engine, a carbureted engine, or any other suitable engine capable of propelling the snowmobile 10.

The engine 26 receives air from the air intake system 50, specifically from a primary airbox 52, via engine air inlets 27 defined in the rear portion of each cylinder of the engine 26. Each air inlet 27 is connected to a throttle body 37 of the air intake system 50. The throttle body 37 includes a throttle valve 39 which rotates to regulate the amount of air flowing through the throttle body 37 into the corresponding cylinder 110 of the engine 26.

A throttle valve actuator (not shown) is operatively connected to the throttle valve 39 to change the position of the throttle valve 39 and thereby adjust the opening of the throttle valve 39 with operation of the throttle lever 86 on the handlebar 84. The position and the movement of the throttle valve 39 is monitored by a throttle valve position sensor (not shown) operatively connected to the throttle valve 39. In the present embodiment, the throttle valve actuator is in the form of an electric motor (not shown). The electric motor changes the position of the throttle valve 39 based on input signals received from an electronic control module (not shown) which in turn receives inputs signals from a position sensor associated with the throttle lever 86 on the handlebars 84. Further details regarding such drive—by wire throttle systems can be found in U.S. Pat. No. 10,029,567, issued on Jul. 24, 2018, the entirety of which is incorporated herein by reference. It is also contemplated the throttle valve actuator could ne implemented by a mechanical linkage.

The engine 26 receives fuel from the fuel tank 28 via Direct Injection (DI) injectors 41 and Multi Point Fuel Injection (MPFI) injectors 45 (both shown in at least FIG. 3), having an opening in the cylinders 105 for providing fuel to the combustion chambers 110. The fuel-air mixture in each of the left and right combustion chambers 110 of the engine 26 is ignited by an ignition system including spark plugs 43 (best seen in FIG. 2). Engine output power, torque and engine speed are determined in part by throttle opening and in part by the ignition timing as well as by various characteristics of the fuel-air mixture such as its composition, temperature, pressure and the like.

Exhaust gases resulting from the combustion events of the combustion process are expelled from the engine 26 via an exhaust system 17. As shown in FIG. 3, an exhaust outlet 29 is defined in the front portion of each cylinder of the engine 26. The exhaust outlets 29 are fluidly connected to an exhaust manifold 33. The exhaust system 17 also includes a muffler 19 (FIG. 2) fluidly connected to the exhaust manifold 33.

The vehicle 10 also includes a turbocharger 73 operatively connected to the engine 26. The turbocharger 73 compresses air and feeds it to the engine 26. As shown in FIG. 3, the turbocharger 73 has an air compressor 75 and an exhaust turbine 77. The air compressor 75 includes a compressor wheel and is part of the air intake system 50. Intake air flowing past the rotating compressor wheel is compressed thereby. The rotation of the compressor wheel is powered by a turbine wheel (not shown) of the exhaust turbine 77, which is part of the exhaust system 17 (parts of the exhaust system 17 connecting the turbine 77 to the engine 26 have been omitted to simplify the figures). The turbine wheel is rotated about a turbine axis (not shown) by exhaust gases expelled from the engine 26 and directed to flow over the blades of the turbine wheel. It is contemplated that, in some implementations, the air compressor 75 could be a supercharger, in which the compressor wheel would be directly powered by the engine 26. While the current technology is described herein for a turbocharged engine assembly 126, it is contemplated that in some non-limiting embodiments the turbocharger 73 could be omitted (e.g. if the engine is an outboard engine for a personal watercraft).

The vehicle 10 further includes a system controller 55 (shown schematically) operatively connected to an engine control unit (or ECU) and/or the electrical system (not shown) of the snowmobile 10. The engine control unit is in turn operatively connected to the engine 26.

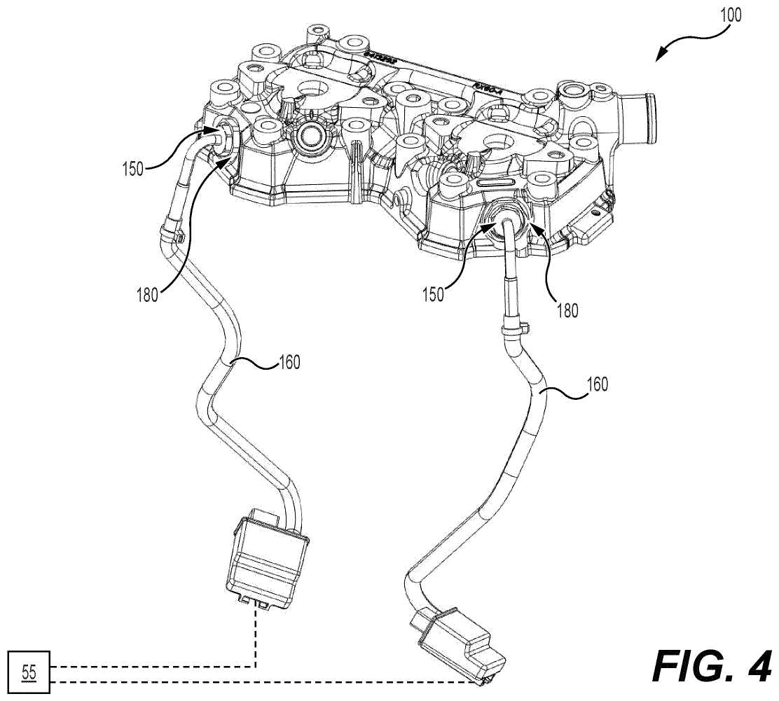

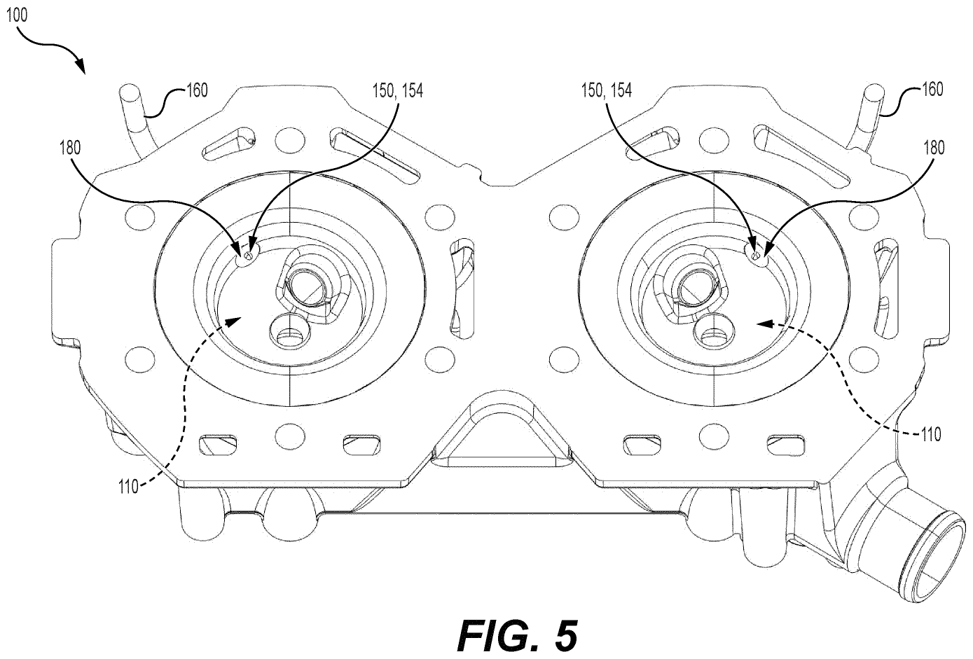

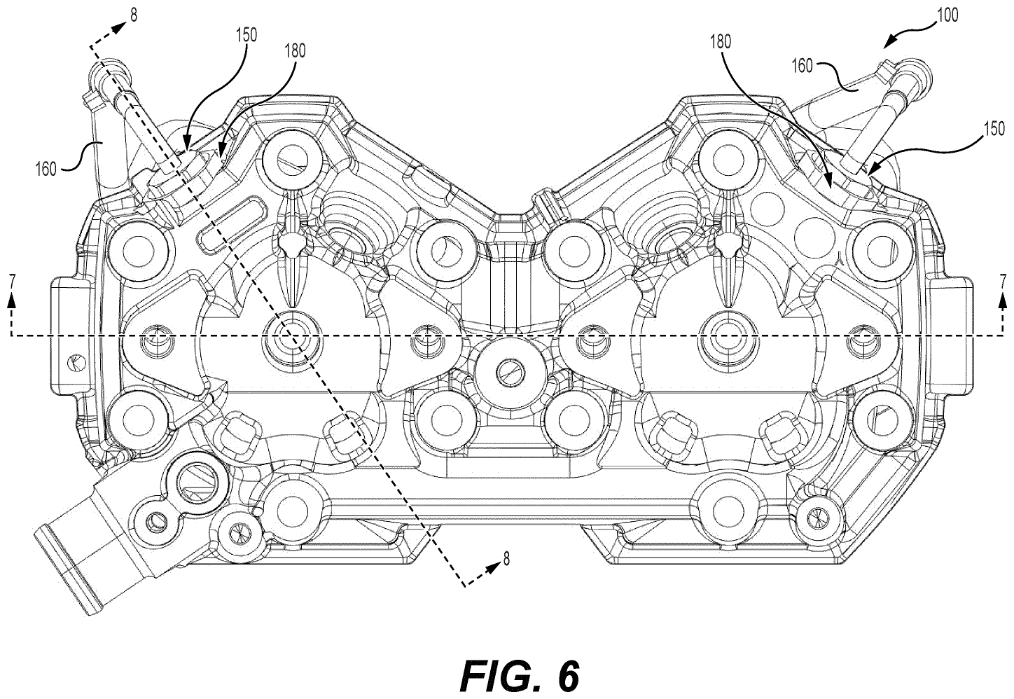

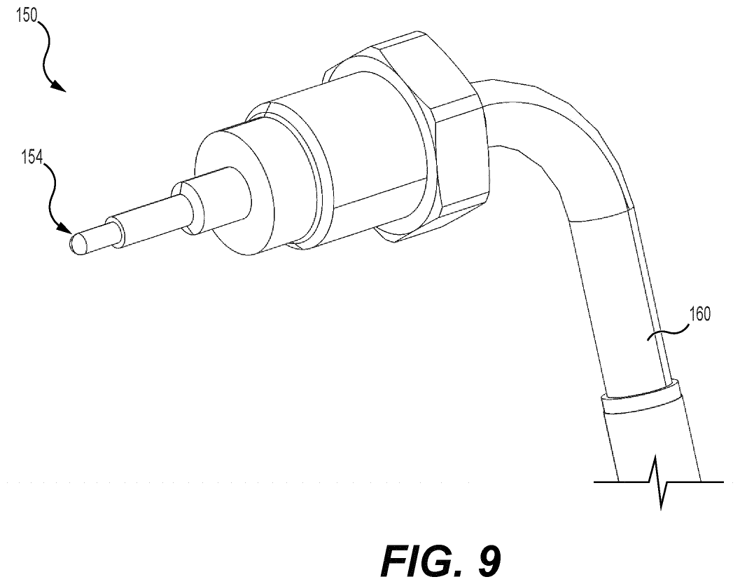

With reference to FIGS. 4 to 9, the engine assembly 126 includes the two temperature sensors 150 mentioned briefly above; one such sensor 150 is shown in isolation in FIG. 9. Each sensor 150 is configured and arranged for determining a temperature of fluids within one of the combustion chambers 110. In the present embodiment, the temperature of fluids (i.e. air and fuel) within the combustion chambers 110 sensed by the sensor 150 is used to estimate a temperature of the pistons 95, the piston pins thereof and/or piston bosses thereof. To determine the temperature of a given piston 95, a linear offset, i.e. a constant value of 180° C. (in the present embodiment), is added to a temperature sensed by the respective temperature sensor 150. The linear offset could vary depending on the embodiment and is determined for a particular embodiment of the engine 26 by initial calibration testing by directly monitoring an actual temperature of the pistons 95. As temperature sensors configured to directly monitor piston temperature are both expensive and often have short lifetimes due to engine conditions, monitoring the temperature of the fluid in the combustion chamber 110 provides a less expensive, longer lasting alternative. In at least some other embodiments, the temperature or changes in the temperature of fluids within the combustion chambers 110 could be treated as representative of the temperature of the respective piston 95.

While the present embodiment includes one sensor 150 for each of the combustion chambers 110, it is contemplated that the assembly 126 could include only one sensor 150 arranged to determine a temperature of one of the combustion chambers 110. It is also contemplated, for embodiments of the engine 26 with more than two cylinders 105/combustion chambers 110 and pistons 95, that the engine assembly 126 could include more than two sensors 150. It is further contemplated that the engine 26 could include more than two pistons 95 and corresponding cylinders 105, while including two or less temperature sensors 150.

In the illustrated embodiment, each temperature sensor 150 is connected to and extends through the cylinder head 100. Details pertaining to the manner of connection of the sensors 150 to the cylinder head 100 are described further below. It is contemplated that temperature sensors 150 could be connected to the engine block 90 in some embodiments. Specific placement of the sensors 150 could depend on various factors, including space available surrounding the engine 26 and a travel path of the pistons 95 in the cylinders 105.

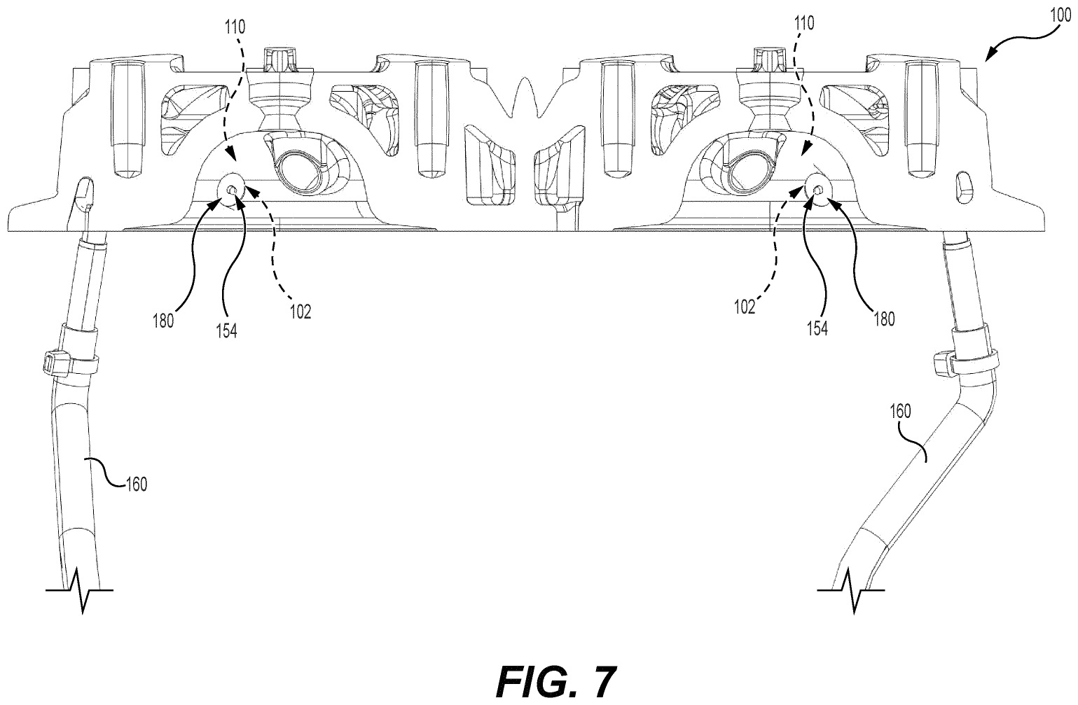

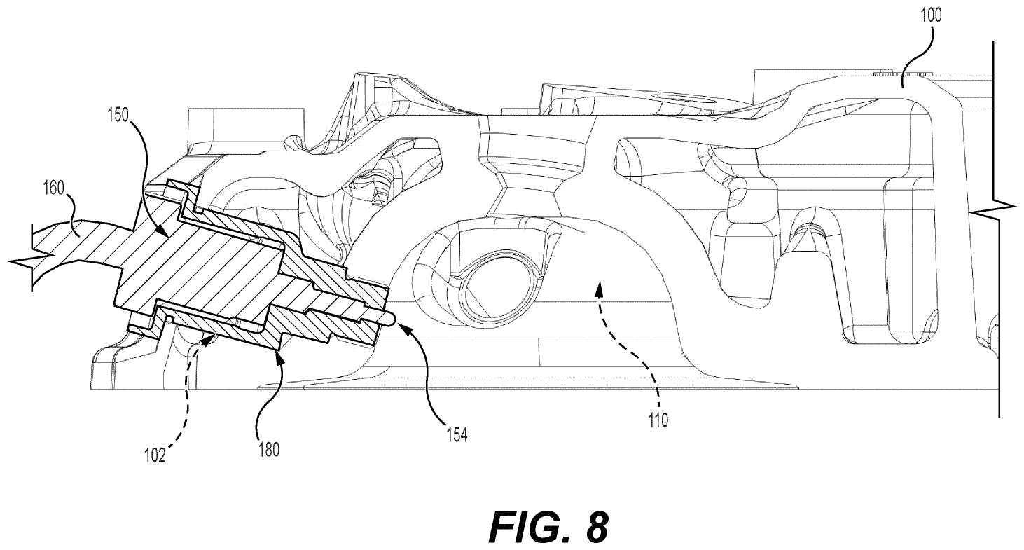

As can be seen in at least FIGS. 7 and 8, the cylinder head 100 defines therein two openings 102 for receiving the sensors 150. Each opening 102 extends from a rear, exterior side of the cylinder head 100 through to one of the combustion chambers 110. It is contemplated that one or both openings 102 could be defined in a front side of the cylinder head 100 or a corresponding one of the left and right sides of the cylinder head 100.

According the present non-limiting embodiment, the temperature sensors 150 are thermocouple sensors 150. It is contemplated that one or both the temperature sensors 150 could be differently implemented, including using, for example, resistance temperature detectors. Each sensor 150 has a distal end 154 which protrudes at least partially into the corresponding combustion chamber 110 when installed in the cylinder head 100. Approximately a third of the distal end 154 of the sensor 150 is in the chamber 110 (see FIG. 8), but it is contemplated that the sensor 150 could extend farther or less far into the chamber 110 depending on the embodiment or placement of the sensor 150. Each temperature sensor 150 is communicatively connected to a cable 160 for transferring temperature information, each cable 160 being communicatively connected to the system controller 55 (see FIG. 4). In some embodiments, the sensors 150 could connect instead to the ECU via the cables 160.

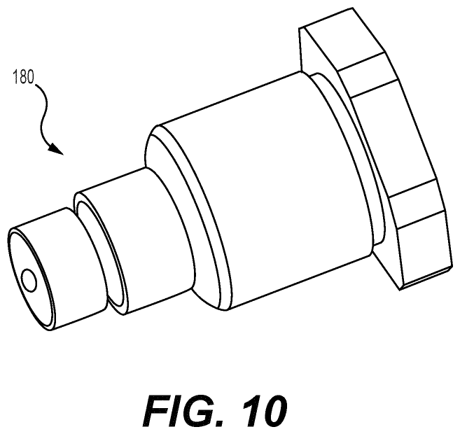

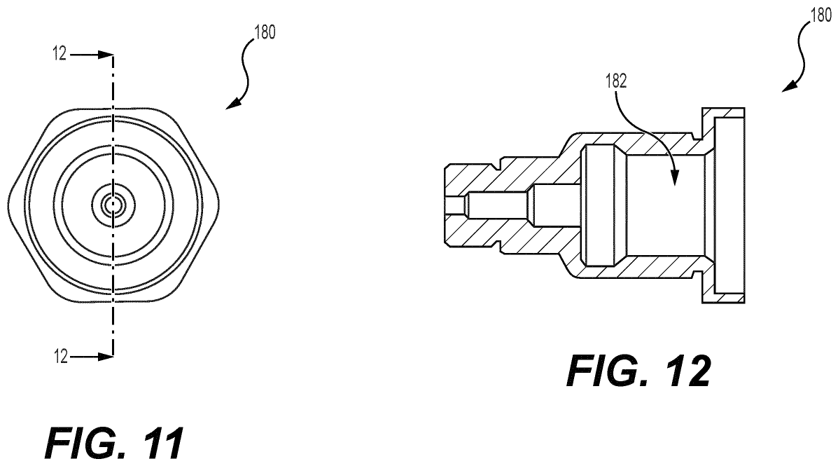

With continued reference to FIG. 8 and additional reference to FIGS. 10 to 12, the illustrated non-limiting embodiment includes sensor sleeves 180 for connecting the temperature sensors 150 to the cylinder head 100. The sensor sleeves 180 are formed from stainless steel. One sensor sleeve 180 is disposed in each opening 102 in the cylinder head 100 (FIG. 8). An interior 182 of the sleeve 180 is sized and shaped to receive one of the sensors 150 therein (FIG. 12). Each of the sensors 150 is press-fit into a corresponding one of the sleeves 180 to aid in maintaining the sensor 150 in its position in the cylinder head 100. It at least some embodiments, it is contemplated that the sleeves 180 could be omitted, and the openings 102 could be sized and shaped for receiving the sensors 150 directly therein. It is also contemplated that the sleeves 180 could be integrally formed with the cylinder head 100.

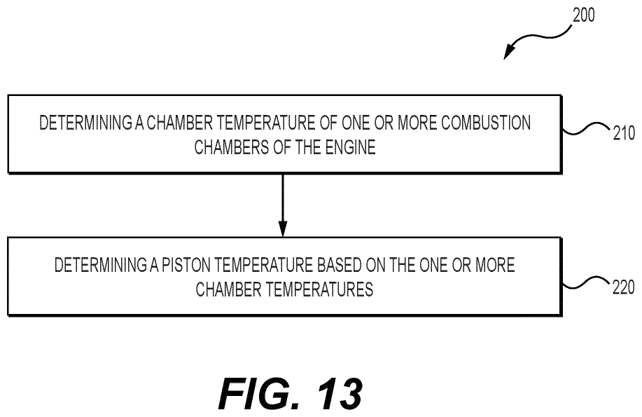

With reference to FIG. 13, a non-limiting implementation of a method 200 for determining piston temperature in an engine 26. The method 200 is performed by the system controller 55 according to the present technology. In some implementations, it is contemplated that an additional or substitute computational system could be implemented to perform the method 200.

The method 200 begins at step 210 with determining, by one or both of the temperature sensors 150 connected to the controller 55, a chamber temperature of fluid within one or both of the combustion chambers 110 of the engine 26.

The method 200 continues, at step 220, with determining, by the system controller 55, the piston temperature based on the chamber temperature of the combustion chamber 110. In the illustrated embodiment, the method 200 includes determining the piston temperature of the piston 95 of each of the cylinders 105. In some embodiments, only one or some of the temperatures of the combustion chambers 110 and/or pistons 95 may be determined.

In some embodiments, determining the piston temperature could include calculating a piston temperature using the determined temperature of fluids in the combustion chamber 110. In some cases, calculating the piston temperature could include adjusting a sensed temperature by a linear offset value or constant value to the chamber temperature.

In at least some embodiments, the method 200 could further include determining the linear offset value between a given chamber temperature and a given piston temperature. In at least some embodiments, determining the offset value includes simultaneously measuring a temperature of the combustion chamber 110 using the sensor 150 and measuring a temperature of the respective piston 95 directly, with the engine 26 operating with a variety of different operating parameters. The piston temperature could be measured using an integrated temperature sensor (not illustrated) disposed in the piston 95. In some other embodiments, a remote-sensing thermometer, such as a pyrometer, could be used. A difference between the combustion chamber temperature and the direct piston temperature measurement could then be compared to determining the offset value. In at least some cases, it is also contemplated that a map of offset values could be determined, where the offset applied could vary based on one or more engine operation parameters.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A method for determining a component temperature in an engine, the method being performed by a controller of a vehicle, the method comprising:
determining, by at least one temperature sensor connected to the controller, a chamber temperature of at least one combustion chamber of the engine, at least part of the at least one temperature sensor being in contact with fluid within the at least one combustion chamber; and
determining, by the controller, the component temperature based on the chamber temperature by calculating the component temperature based on the chamber temperature,
calculating the component temperature comprising applying a linear offset value to the chamber temperature.

2. The method of claim 1, wherein determining the component temperature comprises determining at least one of:
a piston temperature of at least one piston of the engine;
a piston boss temperature of at least one piston boss of the engine; and
a piston pin temperature of at least one piston pin of the engine.

3. The method of claim 1, further comprising calibrating the temperature sensor by determining the linear offset value between a given chamber temperature and a given component temperature.

4. The method of claim 1, wherein;
determining the chamber temperature of the at least one combustion chamber comprises:
determining a first chamber temperature of a first combustion chamber of the engine, and
determining a second chamber temperature of a second combustion chamber of the engine;
determining the component temperature based on the chamber temperature comprises:
determining a first temperature for a first piston at least partially defining the first combustion chamber based on the first chamber temperature, and
determining a second temperature for a second piston at least partially defining the combustion chamber based on the second chamber temperature.

1. An engine assembly for a vehicle, the assembly comprising:
an engine defining at least one cylinder, the engine including at least one piston disposed in the at least one cylinder, the at least one piston and the at least one cylinder together defining at least in part at least one variable volume combustion chamber; and
at least one temperature sensor connected to the engine, the at least one temperature sensor being arranged to measure a temperature of fluid within the at least one combustion chamber.

2. The engine assembly of claim 1, wherein:
the engine comprises:
an engine block, and
a cylinder head connected to the engine block;
the at least one cylinder is defined by the engine block;
the at least one combustion chamber being defined by the at least one piston, the at least one cylinder and the cylinder head; and
the at least one temperature sensor is connected to the cylinder head.

3. The engine assembly of claim 2, wherein the at least one temperature sensor extends through the cylinder head and partially into the at least one combustion chamber.

4. The engine assembly of claim 3, wherein the at least one temperature sensor is received in and extends through a sensor sleeve connected to the cylinder head.

5. The engine assembly of claim 1, wherein:
the at least one cylinder includes:
a first cylinder, and
a second cylinder;
the at least one combustion chamber includes:
a first combustion chamber defined in part by the first cylinder, and
a second combustion chamber defined in part by the second cylinder;
the at least one piston includes:
a first piston disposed in the first cylinder, and
a second piston disposed in the second cylinder; and
the at least one temperature sensor is arranged to measure a temperature of fluid within at least one of the first combustion chamber and the second combustion chamber.

6. The engine assembly of claim 5, wherein:
the at least one temperature sensor includes:
a first temperature sensor arranged to measure a first temperature of fluid within the first combustion chamber; and
a second temperature sensor arranged to measure a second temperature of fluid within the second combustion chamber.

7. The engine assembly of claim 6, wherein:
the first temperature sensor is connected to the cylinder head; and
the second temperature sensor is connected to the cylinder head.

8. The engine assembly of claim 7, wherein:
the first temperature sensor extends through a first opening in the cylinder head and at least partially in the first combustion chamber; and
the second temperature sensor extends through a second opening in the cylinder head and at least partially in the second combustion chamber.

9. The engine assembly of claim 1, wherein the engine is a two-stroke engine.

10. The engine assembly of claim 9, further comprising a turbocharger operatively connected to the engine.

11. The engine assembly of any one of claims 1 to 10, wherein the at least one temperature sensor is a thermocouple extending at least partially into the at least one combustion chamber.

12. The engine assembly of any one of claims 1 to 10, wherein the at least one temperature sensor is in contact with the fluid within the at least one combustion chamber.

13. The engine assembly of any one of claims 1 to 10, wherein at least part of the at least one temperature sensor extends into the at least one combustion chamber.

14. A vehicle comprising:
a frame;
an engine supported by the frame, the engine defining at least one cylinder,
the engine including at least one piston disposed in the at least one cylinder, the at least one piston and that at least one cylinder together defining at least in part at least one variable volume combustion chamber; and
at least one temperature sensor connected to the engine, the at least one temperature sensor being arranged to measure a temperature of fluid within the at least one combustion chamber.

15. The vehicle of claim 14, wherein:
the at least one cylinder includes:
a first cylinder defined in the engine, and
a second cylinder defined in the engine;
the at least one combustion chamber includes:
a first combustion chamber defined in part by the first cylinder, and
a second combustion chamber defined in part by the second cylinder;
the at least one piston includes:
a first piston disposed in the first cylinder, and
a second piston disposed in the second cylinder; and
the at least one temperature sensor is arranged to measure a temperature of fluid within at least one of the first combustion chamber and the second combustion chamber.

16. The vehicle of claim 15, wherein:
the at least one temperature sensor includes:
a first temperature sensor arranged to measure a first temperature of fluid within the first combustion chamber; and
a second temperature sensor arranged to measure a second temperature of fluid within the second combustion chamber.

17. The vehicle of claim 16, wherein:
the engine comprises:
an engine block, and
a cylinder head connected to the engine block;
the first combustion chamber is defined by the engine block, the first piston, and the cylinder head;
the second combustion chamber is defined by the engine block, the second piston, and the cylinder head;
the first temperature sensor is connected to the cylinder head; and
the second temperature sensor is connected to the cylinder head.

18. The vehicle of claim 17, wherein:
the first temperature sensor extends through a first opening in the cylinder head and at least partially in the first combustion chamber; and
the second temperature sensor extends through a second opening in the cylinder head and at least partially in the second combustion chamber.

19. The vehicle of claim 14, wherein the engine is a two-stroke engine.

20. The vehicle of claim 19, further comprising a turbocharger fluidly connected to the engine.

21. The vehicle of any one of claims 14 to 20, further comprising at least one ski connected to the frame; and
wherein the vehicle is a snowmobile.

22. The vehicle of claim 14, wherein the at least one temperature sensor is in contact with the fluid within the at least one combustion chamber.

23. The vehicle of claim 14, wherein at least part of the at least one temperature sensor extends into that at least one combustion chamber.

24. A method for determining a component temperature in an engine, the method being performed by a controller of a vehicle, the method comprising:
determining, by at least one temperature sensor connected to the controller, a chamber temperature of at least one combustion chamber of the engine, at least part of the at least one temperature sensor being in contact with fluid within the at least one combustion chamber; and
determining, by the controller, the component temperature based on the chamber temperature.

25. The method of claim 24, wherein determining the component temperature comprises determining at least one of:
a piston temperature of at least one piston of the engine;
a piston boss temperature of at least one piston boss of the engine; and
a piston pin temperature of at least one piston pin of the engine.

26. The method of claim 24, wherein determining the component temperature includes calculating the component temperature based on the chamber temperature.

27. The method of claim 26, wherein calculating the component temperature comprises applying a linear offset value to the chamber temperature.

28. The method of claim 27, further comprising calibrating the temperature sensor by determining the linear offset value between a given chamber temperature and a given component temperature.

29. The method of claim 24, wherein:
determining the chamber temperature of the at least one combustion chamber comprises:
determining a first chamber temperature of a first combustion chamber of the engine, and
determining a second chamber temperature of a second combustion chamber of the engine;
determining the component temperature based on the chamber temperature comprises:
determining a first temperature for a first piston at least partially defining the first combustion chamber based on the first chamber temperature, and
determining a second temperature for a second piston at least partially defining the combustion chamber based on the second chamber temperature.
